(19) United States
(12) Patent Application Publication
(10) Pub. No.: US 2026/0003899 A1
(43) Pub. Date: Jan. 1, 2026

(54) DOCUMENT SEARCH SYSTEM

(71) Applicant: Hitachi Vantara, Ltd., Yokohama-shi (JP)

(72) Inventors: Keiichi MATSUZAWA, Tokyo (JP); Mitsuo HAYASAKA, Tokyo (JP)

(21) Appl. No.: 19/074,529

(22) Filed: Mar. 10, 2025

(30) Foreign Application Priority Data
Jun. 28, 2024 (JP) 2024-105557

(51) Int. Cl. G06F 16/3332; G06F 16/34; G06F 40/134

(52) U.S. Cl. CPC G06F 16/3334; G06F 16/345; G06F 40/134

(57) ABSTRACT

A document search system stores a document search database indicating a content hierarchical structure of one or more documents. A document search system receives a search keyword input from a user, searches a document search database for items matching the search keyword, and determines a result item to be presented to the user from a plurality of items matching the search keyword by sequentially selecting items from a higher hierarchy to a lower hierarchy according to a content hierarchical structure including the plurality of items. The selection in at least one hierarchy follows selection by the user from a plurality of option items presented to the user.

### CLAIM OF PRIORITY

The present application claims priority from Japanese patent application JP 2024-105557 filed on Jun. 28, 2024, the content of which is hereby incorporated by reference into this application.

### BACKGROUND OF THE INVENTION

### 1. Field of the Invention

The present invention relates to document search using an input keyword.

### 2. Description of the Related Art

Inquiries from users about products are increasing. A support personnel or automatic response Chatbot searches for a product manual to respond to the inquiry. However, there may be various manuals where the same terms span a plurality of devices and functions. When a large number of results are hit in the keyword search, it takes a lot of time to reach the desired information.

A related art of the present disclosure includes JP 2018-18279 A. JP 2018-18279 A discloses a document search apparatus with which one can narrow down search results to reach desired information faster compared with a case of executing full text search by using classification of attribute information. More specifically, “a document search apparatus 10 includes a reception unit 12 that receives a plurality of search words having a hierarchical relationship, and a setting unit 16 that sets, as a search range of the first search word received by the reception unit 12, a first content among a plurality of contents having a hierarchical relationship included in structured document data 26 and sets, as a search range of a second search word as a hierarchy lower than the first search word, a second content in the same hierarchy as the first content or in a hierarchy lower than the first content” is disclosed (For example, Abstract).

### SUMMARY OF THE INVENTION

JP 2018-18279 A discloses a document search method according a content hierarchical structure. In this method, when a search keyword is designated, a document name including a first keyword of a plurality of documents is extracted, and then a chapter including a second keyword is searched in a content of the document. In this method, a similar procedure is repeated, and a clause, a section, . . . are specified. Thus, the user cannot find a desired chapter or clause unless the user inputs a keyword matching a term of the chapter or clause.

A document search system according to an aspect of the present invention includes a processor, and a storage apparatus. The storage apparatus stores a document search database indicating a content hierarchical structure of one or more documents, and the processor is configured to receive a search keyword input from a user, search the document search database for items matching the search keyword, and determine a result item to be presented to the user from a plurality of items matching the search keyword by sequentially selecting items from a higher hierarchy to a lower hierarchy according to a content hierarchical structure including the plurality of items. The selection in at least one hierarchy follows selection by the user from a plurality of option items presented to the user.

According to the aspect of the present invention, the document can be efficiently searched for according to the input keyword.

### BRIEF DESCRIPTION OF THE DRAWINGS

FIG. 1 is a diagram for describing an outline of a document search system according to a first embodiment;

FIG. 2 illustrates a configuration example of the document search system;

FIG. 3 illustrates a GAD manual;

FIG. 4 illustrates an example of a synonym dictionary;

FIG. 5 illustrates an example of a document search database;

FIG. 6 is a flowchart of a pre-processing example for enabling document search by a user;

FIG. 7 is a flowchart of an example of search processing;

FIG. 8 illustrates an example of interaction between the document search system and the user in document search using an input keyword;

FIG. 9 illustrates a configuration example of a document search system 10 according to a second embodiment;

FIG. 10 illustrates a configuration example of a storage apparatus;

FIG. 11 illustrates a configuration example of various types of information included in configuration information;

FIG. 12 illustrates an example of interaction between a document search system and a user in document search using an input keyword according to the second embodiment; and

FIG. 13 is a flowchart illustrating an example of search processing according to the second embodiment.

### DESCRIPTION OF THE PREFERRED EMBODIMENTS

Hereinafter, embodiments of the present specification will be described with reference to the accompanying drawings. In the accompanying drawings, functionally same elements may be denoted by the same numbers. Note that, although the accompanying drawings illustrate specific embodiments and implementation examples based on the principles of the present invention, the drawings and descriptions are provided for understanding the present invention, and are not used for restrictively interpreting the present invention.

Although the embodiments of the present specification have been described in sufficient detail for those skilled in the art to implement the present invention, it is necessary to understand that other implementations and embodiments can be made, and changes in configurations and structures and replacement of various elements can be made without departing from the scope and spirit of the technical idea of the present invention. Accordingly, the following description should not be interpreted as being limited thereto.

Further, as will be described later, the embodiments of the present specification may be implemented by software running on a general-purpose computer, or may be implemented by dedicated hardware or a combination of software and hardware.

In a case where each processing in the embodiments of the present specification is described with “each processing unit as a program” as a subject (operation subject), since the program performs determined processing by being executed by a processor (CPU or the like) by using a memory and a communication port (communication control apparatus), the description may be made with the processor as the subject.

### First Embodiment

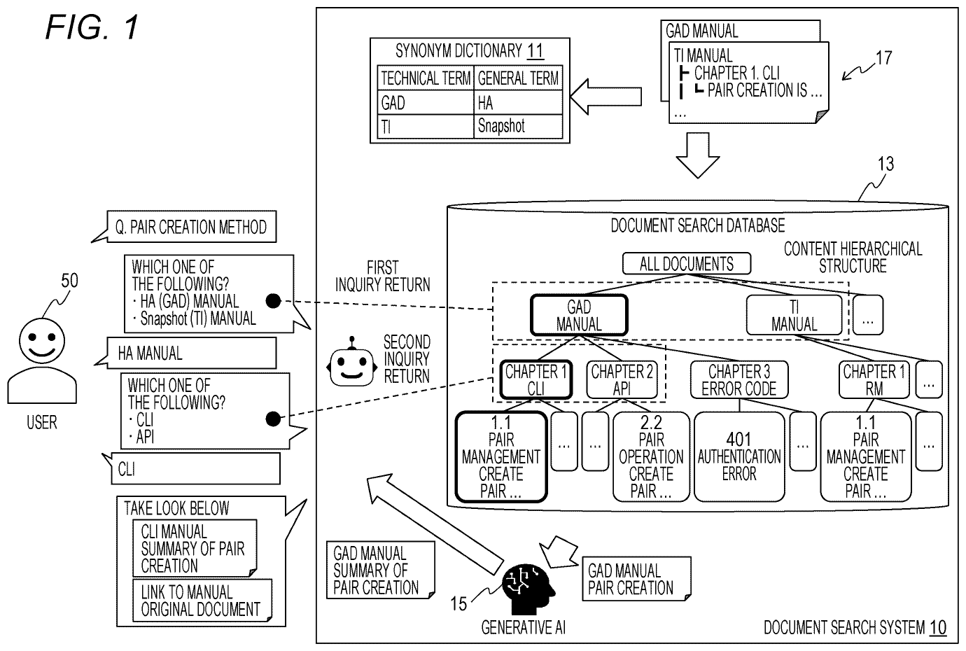

FIG. 1 is a diagram for describing an outline of a document search system 10 according to one embodiment of the present specification. FIG. 1 illustrates an example of the document search system 10 that searches various manuals 17 of a storage system. The manual is an example of a document. FIG. 1 illustrates, as an example of the manual, a global active device (GAD) manual and a thin image (TI) manual which are manuals related to the storage system.

The document search system 10 includes a synonym dictionary 11 and a document search database 13. The synonym dictionary 11 indicates a correspondence relationship between a manual-specific technical term and a general term in the manual 17. The document search database 13 includes information of a content hierarchical structure (by chapter) extracted from each of the various manuals 17 and text (including a title and a body) of each hierarchy. Each document may have a different content hierarchical structure. For example, the content hierarchical structure of the document can include all or part of chapters, clauses, and sections from a higher hierarchy. Note that, the number of hierarchies of each document is arbitrary, and each hierarchy can include the title and/or the body of the corresponding item. In addition, a name of the hierarchy is arbitrary.

The document search system 10 can efficiently search a manual and a description portion in the manual desired by a user through an interaction with a user 50. FIG. 1 illustrates processing of extracting a portion corresponding to an inquiry by the user 50 from the various manuals 17 related to the storage system.

The user 50 inputs a search keyword to the document search system 10. In the example illustrated in FIG. 1, “pair creation method” is input as the search keyword. The document search system 10 searches the document search database 13 for an item (for example, a clause or a section) in a lowest hierarchy of each document matching the search keyword. The lowest hierarchy is a hierarchy under which a hierarchy is not present.

In the example illustrated in FIG. 1, two items of the GAD manual and one item of the TI manual match the search keyword. Specifically, these items are items “1.1 Pair management” and “2.2 Pair operation” in the GAD manual and an item “1.1 Pair management” in the TI manual.

The document search system 10 extracts a content hierarchical structure of a higher hierarchy of the items matching the search keyword from the document search database 13. For example, a title of each hierarchy is extracted. For example, for the item “1.1 Pair management” in the GAD manual, a title “Chapter 1 CLI” of a chapter in a hierarchy immediately above the item and a title “GAD manual” of the manual in this higher hierarchy are extracted. Note that, the CLI represents a command line interface.

The document search system 10 presents information, here, the title to the user 50 from a higher hierarchy to a lower hierarchy of the extracted content hierarchical structure, makes an inquiry return, and sequentially selects items. In presenting the information to the user 50, the document search system 10 refers to the synonym dictionary 11 and converts the manual-specific technical term into the general term. Note that, a part or all of the synonym dictionary 11 or the processing referring thereto may be omitted.

For example, GAD, TI, and RM (RAID manager) are technical terms unique to the manual. On the other hand, a CLI, a graphical user interface (GUI), an application programming interface (API), high availability (HA), and the like are general technical terms (general terms).

As illustrated in FIG. 1, the document search system 10 may describe the technical term and the general term together in presenting the title, or may present only the general term. The general term can make the selection of the user easier. Note that, the synonym dictionary 11 may also be used for the search using the search keyword. The document search system 10 may also search synonyms of the search keyword in the document search database 13.

In the example of FIG. 1, first, the document search system 10 presents candidates for a document in a highest hierarchy and allows the user to select the candidates. In this example, “GAD manual” and “TI manual” are presented, and “GAD manual” is selected.

Next, the document search system 10 presents candidate items in a chapter that is a hierarchy next to the selected “GAD manual”, and allows the user to select the candidate items. Here, “CLI” and “API” are presented, and “CLI” is selected.

The user selection according to the hierarchy is repeated, and thus, an item to be finally presented to the user as a result item of the search is determined. In the example of FIG. 1, the item “1.1 Pair management” in the GAD manual is selected as information to be presented.

The document search system 10 presents information of the selected item to the user. In the example illustrated in FIG. 1, the document search system 10 gives a sentence of the specified item to a generative artificial intelligence (AI) 15, and causes the generative AI to generate a summary sentence. The document search system 10 presents a link to a manual original document to the user together with the summary sentence output from the generative AI 15. As a result, the user can easily know the information of a target item and can easily refer to an original manual. Note that, at least one of the summary sentence and the link may be omitted, and the title of the item may be presented instead.

The above example is to search for an item of the lowest hierarchy matching the search keyword. As a result, the most narrowed item can be presented to the user. In another example, the document search system 10 executes search in a predetermined other hierarchy in addition to the lowest hierarchy. For example, all the hierarchies may be search targets.

When the user selects the item matching the search keyword, the document search system 10 stops the user selection. For example, in the above example, it is assumed that the body (explanatory sentence) of the item “Chapter 1 CLI” includes “pair creation”. When the item “Chapter 1 CLI” is selected by the user, the document search system 10 determines that this item is a final selection item. The document search system 10 generates a summary sentence of this chapter by the generative AI 15 and presents the summary sentence to the user together with a link of the manual original document.

As described above, the user is allowed to select an item in each hierarchy through an interaction, and thus, the user can efficiently search the manual and arrive at desired information. In addition, the general term is presented together with or instead of the technical term, and thus, even a beginner who does not know the technical term can appropriately select an item.

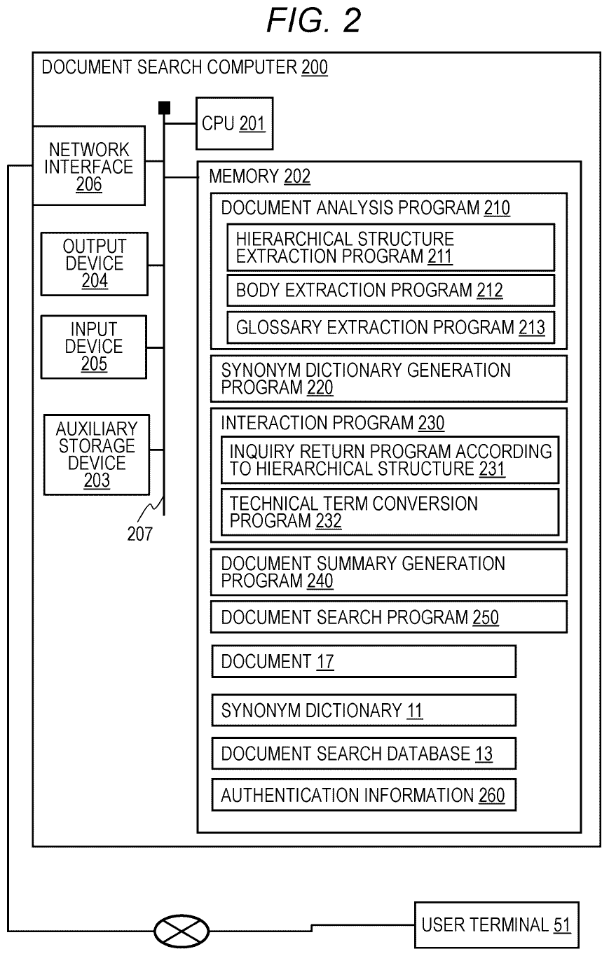

FIG. 2 illustrates a configuration example of the document search system 10 according to one embodiment of the present specification. The document search system 10 includes a document search computer 200 and a user terminal 51, and communicates via a network.

Hereinafter, a hardware configuration example of the document search computer 2 will be described, but the user terminal 3 may have a similar configuration. The document search computer 200 includes a CPU (processor) 201 that executes various programs, a memory (main storage device) 202 that stores various programs, and an auxiliary storage device 203 that stores various types of data. The CPU 201 can include one or more cores, and the memory 202 is, for example, a DRAM including a volatile storage region. The auxiliary storage device 203 is, for example, a hard disk drive (HDD), a flash memory, or the like, and can provide a non-volatile storage region.

The document search computer 200 further includes an output device 204 that presents information to a user of the apparatus, an input device 205 that inputs an instruction, an image, or the like by the user, and a network interface 206 that communicates with another apparatus. These devices are connected to each other by a bus 207. The user may use the user terminal 51 connected to the document search computer 200 via a network instead of the input and output devices of the document search computer 200.

Functional units of the document search computer 200 can be implemented, for example, by the CPU 201 operating according to the program. The CPU 201 reads and executes various programs from the memory 202 as necessary. The memory 202 can store programs and data used by the programs. Each program and reference data are loaded from the auxiliary storage device 203 to the memory 202, for example, and are executed and processed by the CPU 201. Note that, at least a part of the functional units may be a logic circuit.

The output device 204 includes devices such as a display, a printer, and a speaker. The input device 205 includes devices such as a keyboard, a mouse, and a microphone. The output device 204 presents an input result from the user and presents a processing result by the document search computer 200. An instruction from the user is input to the document search computer 200 by the input device 205. Note that, in a case where the user terminal 51 is used, the input and output devices function similarly, and the output device 204 and the input device 205 can be omitted.

The network interface 206 receives, for example, data transmitted from another apparatus connected via a network including the user terminal 51, and transmits a processing result by the document search computer 200 to another apparatus. Note that, some devices may be omitted.

The document search computer 200 stores a document analysis program 210 and a synonym dictionary generation program 220. The document analysis program 210 and the synonym dictionary generation program 220 execute pre-processing for searching by the user. Note that, processing results by the document analysis program 210 and the synonym dictionary generation program 220 may be prepared in advance by a system designer.

The document analysis program 210 includes a hierarchical structure extraction program 211, a body extraction program 212, and a glossary extraction program 213. The hierarchical structure extraction program 211 refers to the content of the document and extracts the content hierarchical structure. The body extraction program 212 extracts a body in each hierarchy in the document. The glossary extraction program 213 extracts a glossary included in the document. The glossary is an item that explains the terms in the document. The synonym dictionary generation program 220 generates the synonym dictionary 11.

The document search computer 200 further includes an interaction program 230, a document summary generation program 240, and a document search program 250. The interaction program 230 includes an inquiry return program 231 and a technical term conversion program 232 according to a hierarchical structure.

The interaction program 230 is a program for executing an interaction with the user 50 for document search. The inquiry return program 231 according to the hierarchical structure returns an inquiry in response to an input of the search keyword and an answer to the inquiry return from the user 50. The technical term conversion program 232 uses the synonym dictionary 11 to convert technical terms in the information of the document to be presented to the user into general terms.

The document summary generation program 240 includes the generative AI 15 and generates a summary to be presented to the user 50 from one or more items in the document. The generative AI 15 may operate on another computer and may be called by the document summary generation program 240. The document search program 250 extracts an item matching the search keyword input by the user 50 and a higher hierarchy thereof from the document search database 13.

The document search computer 200 stores data to be referred to or processed by the program. Specifically, the document search computer 200 stores the document 17, the synonym dictionary 11, the document search database 13, and authentication information 260. The authentication information 260 is used to access configuration information of a storage apparatus described in a second embodiment.

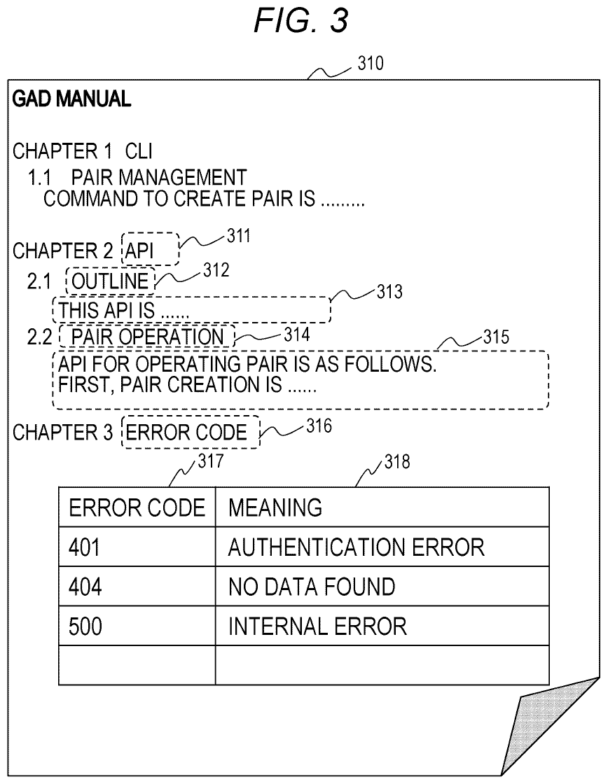

FIG. 3 illustrates a GAD manual 310 as an example of one document included in the document 17. The GAD manual 310 includes three chapters, and titles thereof are “CLI”, “API”, and “error code”. Chapter 1 CLI includes one clause “1.1 Pair management”. Chapter 2 API includes two clauses “2.2 Outline” and “2.2 Pair operation”. Chapter 3 Error code is a table that associates error codes with meanings.

A content hierarchical structure of the GAD manual 310 will be described. For example, a hierarchy (item) of Chapter 2 includes a title “API” 311 and does not include a body. A hierarchy of Clause 2.1 includes a title “Outline” 312 and a body 313. A hierarchy of Clause 2.2 includes a title “Pair operation” 314 and a body 315.

A hierarchy of Chapter 3 includes a title “error code” 316 and does not include a body. An item of a lower hierarchy is each entry of the table. One entry constitutes one item immediately below Chapter 3. In each item, an error code 317 is a title, and a meaning 318 of the error code is a body.

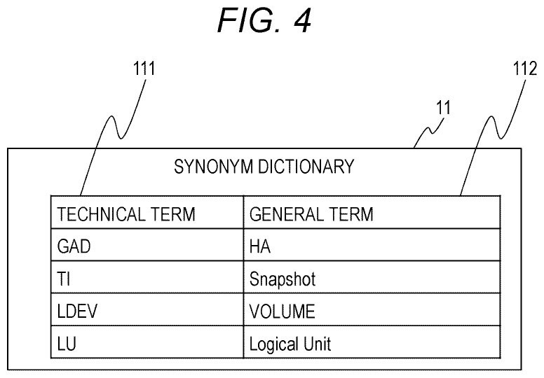

FIG. 4 illustrates an example of the synonym dictionary 11. The synonym dictionary 11 indicates a correspondence between the manual-specific technical term and the general term. In the structure example illustrated in FIG. 4, the synonym dictionary 11 includes a technical term field 111 and a general term field 112. The general term field 112 indicates a general term corresponding to each manual-specific technical term indicated by the technical term field 111. Like “LU” and “Logical Unit” illustrated in FIG. 4, an abbreviation and an official name may have a relationship between the technical term and the general term.

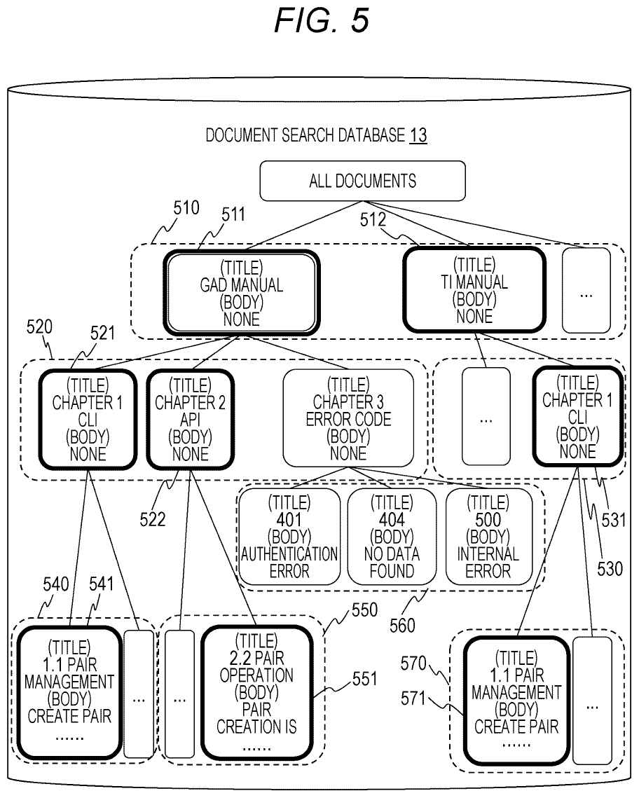

FIG. 5 illustrates an example of the document search database 13. The document search database 13 manages the content hierarchical structure of each of the documents 17. FIG. 5 illustrates, as an example, a document with a title “GAD manual” and a document with a title “TI manual” in the document 17. The document 17 includes more documents. The number of documents registered in the document search database 13 is any number of 1 or more.

The document search database 13 includes information of a content hierarchical structure (by chapter) extracted from each of the various manuals 17 and text (including a title and a body) of each hierarchy. Each document may have a different content hierarchical structure. The number of hierarchies of each document and the number of items in each hierarchy are arbitrary, and the items in each hierarchy may include a title and/or a body.

In FIG. 5, a highest hierarchy 510 is a hierarchy of the document and includes items of the document. In FIG. 5, “GAD manual” and “TI manual” are illustrated, and each of “GAD manual” and “TI manual” does not include the body but includes only the title. Note that, an example of the GAD manual is illustrated in FIG. 3.

A next lower hierarchy 520 of the GAD manual is a hierarchy of the chapter, and includes three items of Chapter 1, Chapter 2, and Chapter 3. Each item includes a title and does not include a body. A next lower hierarchy 540 of the item of “Chapter 1 CLI” is a hierarchy of a clause and includes a plurality of items. FIG. 5 illustrates one item “1.1 Pair management” as an example. This item includes a title “1.1 Pair management” and a body “create pair . . . ”.

A next lower hierarchy 550 of the item of “Chapter 2 API” is a hierarchy of a clause and includes a plurality of items. FIG. 5 illustrates one item “2.2 Pair operation” as an example. This item includes a title “2.2 Pair operation” and a body “pair creation is . . . ”. A next lower hierarchy 560 of the item of “Chapter 3 Error code” is a hierarchy corresponding to the table and includes a plurality of items. FIG. 5 illustrates three items as an example. These items include titles and bodies. As illustrated in FIG. 3, the title indicates the error code, and the body indicates the meaning of the error code.

A next lower hierarchy 530 of the TI manual is a hierarchy of the chapter and includes a plurality of items. FIG. 5 illustrates the item “Chapter 1 CLI” as an example. This item includes a title and does not include a body. A next lower hierarchy 570 of the item of “Chapter 1 CLI” is a hierarchy of the clause and includes a plurality of items. FIG. 5 illustrates one item “1.1 Pair management” as an example. This item includes a title “1.1 Pair management” and a body “create pair . . . ”.

As described with reference to FIG. 1, it is assumed that the user 50 inputs “pair creation method” as the search keyword. Here, the document search system 10 searches for an item matching the search keyword in the title and the body in each item of the document search database 13. In the example of FIG. 5, a phrase matching the search keyword has been found in bodies of items 541, 551, and 571. These items are candidates for an item intended by the user 50.

The document search system 10 extracts a hierarchical structure including the item matching the search keyword, that is, extracts this item and an item in a higher hierarchy. In the example illustrated in FIG. 5, items in higher hierarchies of the item 541 are an item 521 and an item 511. Items in higher hierarchies of the item 551 are an item 522 and an item 511. Items in higher hierarchies of the item 571 are an item 531 and an item 512.

As described with reference to FIG. 1, the document search system 10 narrows down items from the higher hierarchies in the interaction with the user 50, and determines an item of which information is finally presented to the user 50. Note that, the search target in the document search database 13 may be only an item in a lowest hierarchy (a hierarchy in which the lower hierarchy is not present) or may be only the body of each item.

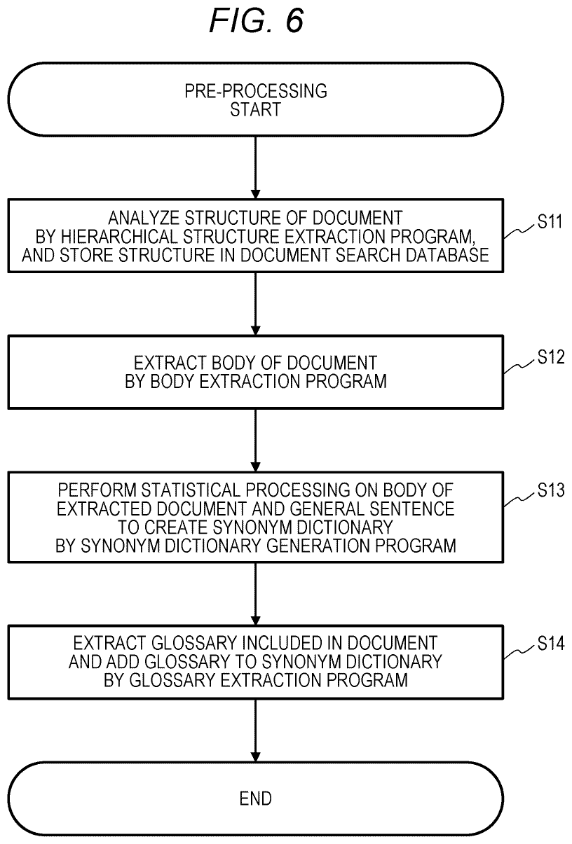

Next, processing by the document search system 10 will be described. FIG. 6 is a flowchart of a pre-processing example for enabling document search by the user 50. In the pre-processing, the document search database 13 and the synonym dictionary 11 are created. Note that, the document search database 13 and the synonym dictionary 11 may be prepared in advance by the system designer instead of the document search system 10.

Pre-processing for one document will be described with reference to FIG. 6. The hierarchical structure extraction program 211 analyzes a structure of the document and stores the structure in the document search database 13 (S11). Various document structure analysis techniques are known, and a detailed description thereof is omitted. The hierarchical structure extraction program 211 may use any document structure analysis technique.

Next, the body extraction program 212 extracts a body from the document in the document search database 13 (S12). Subsequently, the synonym dictionary generation program 220 executes statistical processing by combining the extracted body of the document and a general sentence such as a sentence disclosed on a work with each other to create a synonym dictionary (S13). The creation of the synonym dictionary can use a word embedding technique for generating a vector of words. Note that, various techniques for creating the synonym dictionary are known, and, for example, Word2Vec or the like can be applied. The synonym dictionary generation program 220 may use any technique.

Next, the glossary extraction program 213 extracts the glossary in the document and adds glossary terms as technical terms to the synonym dictionary 11 (S14). For example, pairs of abbreviation and official names or terms generated from an explanatory sentence of the glossary may be registered as general terms.

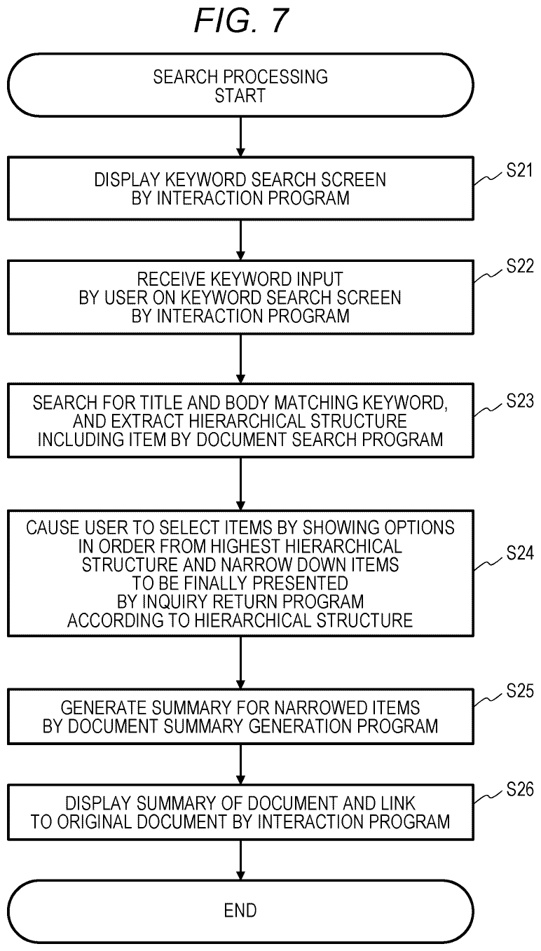

Next, search processing by the document search system 10 will be described. FIG. 7 illustrates a flowchart of an example of the search processing. First, the interaction program 230 displays a keyword search screen on a display device of the user terminal 51 (S21). The user 50 inputs the search keyword on the keyword search screen, and the interaction program 230 receives the search keyword (S22).

Next, the document search program 250 searches for a title and a body matching the search keyword, and extracts a hierarchical structure including the items (S23). Known techniques can be used to search for a sentence (including the title) matching the search keyword. For example, one method is to search for a sentence including an input keyword or a synonym thereof in the sentence. At this time, the document search program may refer to the synonym dictionary 11 to absorb a notation deviation between the technical term and the general term in the keyword search. Moreover, the input keyword is decomposed by an N-gram to determine whether or not the input keyword is included in the sentence, or the input keyword is converted into a vector embedding to search for a sentence to be converted into a close vector.

Next, the inquiry return program 231 according to the hierarchical structure causes the user 50 to select items by showing options of the items in order from the highest hierarchy of the extracted hierarchical structure, and narrows down the items to be finally presented (S24). The presentation of the options may, for example, display a title of the item or display the title and a summary of a body. The summary can be generated by the document summary generation program 240. As a result, information useful for selection can be shown to the user. The inquiry return program 231 according to the information hierarchical structure converts the technical term into the general term by the technical term conversion program 232 and displays the general term instead of the technical term or together with the technical term. As a result, the user can easily understand the inquiry return without knowledge of the technical term.

Next, the document summary generation program 240 generates a summary for the narrowed items by using the generative AI 15. Here, the document summary generation program 240 generates the narrowed items or a summary of the narrowed items and a body in the lower hierarchy (S25). The summary enables efficient details understanding by the user. Note that, the summary may be generated without using the generative AI 15. Next, the interaction program 230 displays a summary of the document and a link to the original document (S26). As a result, this flow ends.

Here, the narrowing down of the items and the generation of the summary by the interaction will be described with reference to FIG. 5. In the example illustrated in FIG. 5, items matching the input keyword are the item 541 and the item 531. The items in the higher hierarchies of the item 541 are the items 521 and 511. An item in a higher hierarchy of the item 531 is the item 512.

The inquiry return program 231 presents, as the options, the items 511 and 512 in the highest hierarchy 510 to the user 50. In a case where the user 50 selects the item 511, an item of which a summary is finally provided to the user is the item 541. The item 541 is the lowest hierarchy, and there is no lower hierarchy. The document summary generation program 240 generates a summary of the item 541.

On the other hand, in a case where the user 50 selects the item 512 in the hierarchy 510, an item of which a summary is finally provided to the user is the item 531. The hierarchical structure of the item 531 includes a lower hierarchy 570. The document summary generation program 240 generates a summary from a body of the item 531 and an item in the lower hierarchy 570.

Another example will be described. It is assumed that one item matches the search keyword, and a plurality of items in one lower hierarchy matches the search keyword. For example, it is assumed that the item 521 and the item 541 and another item in the lower hierarchy 540 match the search keyword. The inquiry return program 231 may execute necessary selection up to a lowest hierarchy in which an item matching the search keyword is present to select one of the three items, and may stop the inquiry return and display the item 521 and the summary of the lower hierarchy at a point in time when the item 521 is selected. Here, the user may select one item from the item 541 and another item in the lower hierarchy 540. As a result, a portion to be referred to by the user 50 can be further narrowed down.

In a case where the items in both the higher hierarchy and the lower hierarchy match the search keyword, for example, in a case where both the item 541 and the item 521 in the higher hierarchy match the search keyword, the document summary generation program 240 may generate a summary of the items in the lower hierarchy without referring to the item in the higher hierarchy.

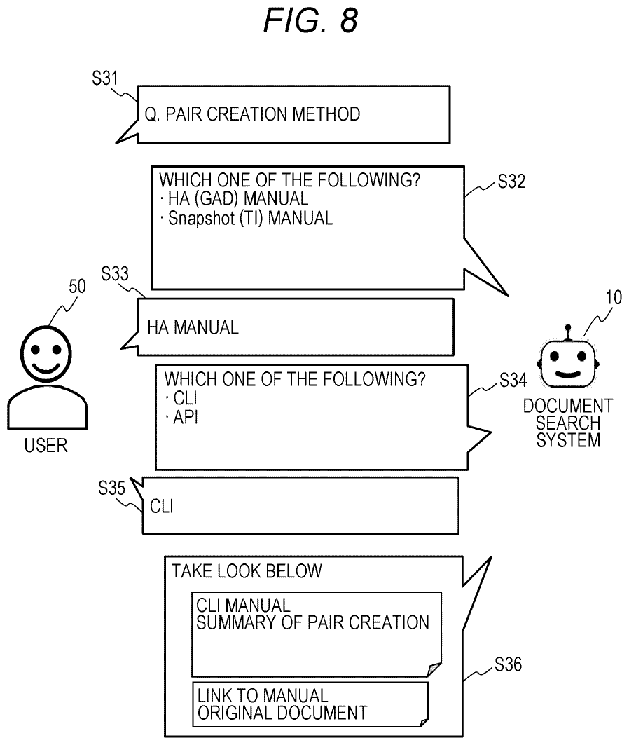

FIG. 8 illustrates an example of the interaction between the document search system 10 and the user 50 in the document search using the input keyword. FIG. 8 corresponds to the interaction described with reference to FIG. 1. The user 50 inputs “pair creation method” as the search keyword on the user terminal 51 (S31).

The document search system 10 finds the items 541, 551, and 571 matching the input keyword in the document search database 13 illustrated in FIG. 5. The document search system 10 presents, as the options, the items 511 and 512 in the hierarchy 510 from the hierarchical structure of the items 541, 551, and 571 (S32). That is, the GAD manual and the TI manual, which are titles thereof, are presented as the options. At this time, GAD and TI as the technical terms are converted into HA and Snapshot as the general terms, and the technical terms and the general terms are written together.

Next, the user 50 selects the GAD manual from the GAD manual and the TI manual (S33). Next, the document search system 10 presents, as the options, the items 521 and 522 in the hierarchy 520 (S34). That is, CLI and API, which are titles thereof, are presented as the options.

Next, the user 50 selects CLI from CLI and API (S35). The document search system 10 generates a summary of a body of the item 541 and presents the summary to the user 50 along with a link to the GAD manual (S36).

As described above, in the content hierarchical structure of the keyword search result (found candidate item), the user is allowed to select the item while showing the title of the item in each hierarchy from the higher hierarchy to the lower hierarchy, and thus, it is possible to efficiently find the item of which information is presented to the user. Note that, the interaction may be executed by voice information instead of the interaction by character information (visual information) described above.

### Second Embodiment

Hereinafter, one embodiment of the present specification will be described. Differences from the first embodiment will be mainly described. The description in the first embodiment may be applied to the present embodiment unless otherwise specified. In the present embodiment, the document search system 10 automatically selects an item with reference to configuration information of a storage apparatus used by the user in the content hierarchical structure, and reduces the number of times of inquiry return to the user.

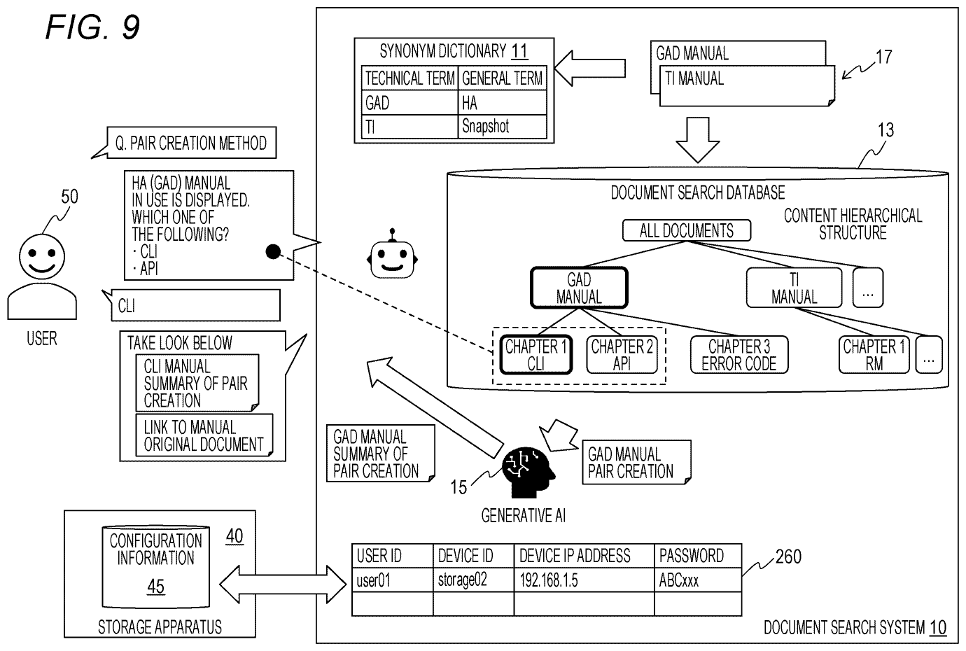

FIG. 9 illustrates a configuration example of a document search system 10 according to one embodiment of the present specification. The document search system 10 obtains configuration information from an apparatus used by a user by using authentication information 260 for accessing the apparatus. In the configuration example illustrated in FIG. 9, an apparatus used by a user 50 is a storage apparatus 40.

The authentication information 260 includes a user ID field, a device ID field, a device IP address field, and a password field. The user ID field indicates a user ID. The device ID field indicates an ID of a device used by the user. The device IP address field indicates an IP address of the device. The password field indicates a password for accessing the device to acquire configuration information. The authentication information 260 is registered in the document search system 10 in advance.

For example, the document search system 10 includes a field for inputting the user ID on a keyword search screen, and acquires the user ID from the user 50. The document search system 10 acquires information for accessing the storage apparatus 40 used by the user from the authentication information 260 by using the acquired user ID as a key. The document search system 10 accesses the IP address of the storage apparatus 40 acquired from the authentication information 260, and acquires configuration information 45 from the storage apparatus 40 through authentication using the password.

In the present embodiment, the document search system 10 refers to the configuration information 45 of the storage apparatus 40 used by the user 50, and generates an inquiry return to a search request designating a keyword from the user 50. In the example illustrated in FIG. 9, a first inquiry return by the document search system 10 is selection of “CLI” and “API” in a GAD manual. In the configuration example illustrated in FIG. 1, before presenting this option, options of the GAD manual and a TI manual are presented to the user 50. In the present embodiment, this first inquiry return is omitted based on the configuration information of the storage apparatus 40 used by the user, and the GAD manual is automatically selected.

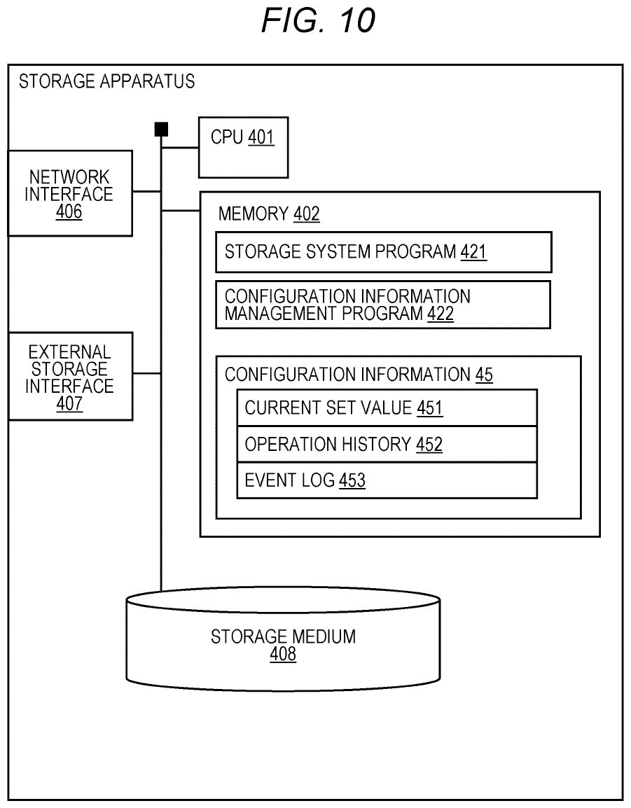

FIG. 10 illustrates a configuration example of the storage apparatus 40. The storage apparatus 40 includes a CPU 401 that executes various programs, a memory 402 that stores the various programs, and a storage medium 408 that stores data (host data) from a host. The CPU 401 can include one or more cores, and the memory 402 is, for example, a DRAM including a volatile storage region. The storage medium 408 includes a plurality of storage drives, and the storage drive is, for example, an HDD or a solid state drive (SSD).

The storage apparatus 40 includes a network interface 406 for communicating with the host and the document search system 10, and an external storage interface 407 for communicating with other storage apparatuses. These interfaces are mutually connected to each other by an internal network.

The memory 402 stores a program executed by the CPU 401 and the configuration information 45 of the storage apparatus 40. A storage system program 421 and a configuration information management program 422 are illustrated as an example of the program. The storage system program 421 executes processing including processing of an IO request for the storage apparatus 40 and related to the host data. The configuration information management program 422 manages the configuration information 45 and updates the configuration information 45 according to an operation of the storage apparatus 40.

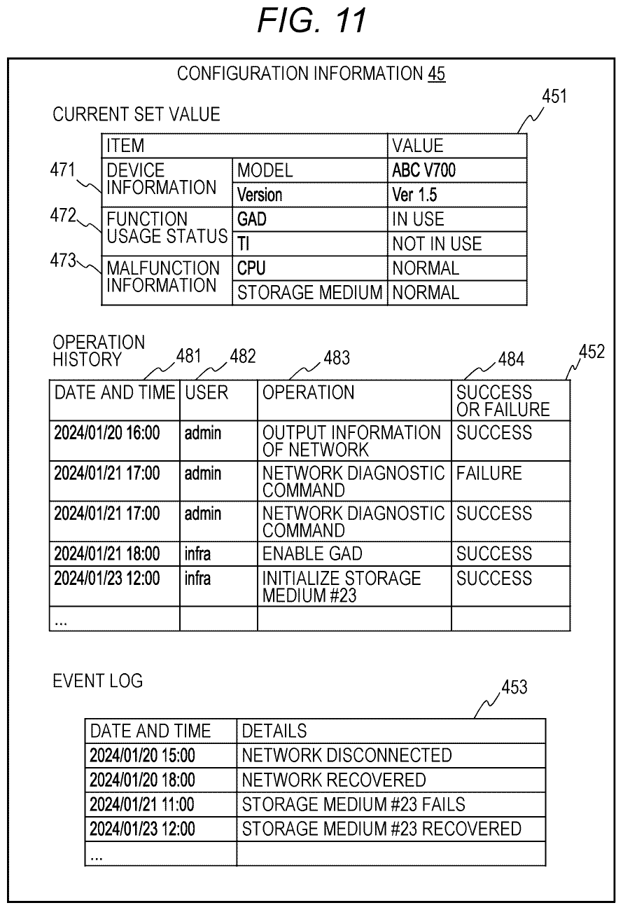

The configuration information 45 includes a current set value 454, an operation history 452, and an event log 453. FIG. 11 illustrates a configuration example of various types of information included in the configuration information 45. The current set value 451 includes device information 471, a function usage status 472, and malfunction information 473. The device information 471 includes a model name and a version. The function usage status 472 indicates whether or not each of functions implemented in the storage apparatus 40 is used. In the example of FIG. 11, a GAD function is used and a TI function is unused. The malfunction information 473 is information of malfunction in the storage apparatus 40 and indicates a component in which the malfunction occurs.

The operation history 452 indicates a history of operations on the storage apparatus 40. The operation history 452 includes a date and time field 481, a user field 482, an operation field 483, and a success and failure field 484. The date and time field 481 indicates a date and time of the operation. The user field 482 indicates a user who performs the operation. The operation field 483 indicates details of the operation. A success and failure field 484 indicates success or failure of the operation.

The event log 453 is a log of an event that occurs in the storage apparatus 40. The event log indicates a date and time of occurrence of the event and the details thereof.

Returning to FIG. 9, the document search system 10 refers to the configuration information 45 of the storage apparatus 40 used by the user 50, and generates the inquiry return to the search request designating the keyword from the user 50. In the example illustrated in FIG. 9, a first inquiry return by the document search system 10 is selection of “CLI” and “API” in a GAD manual.

The inquiry return program 231 according to the hierarchical structure refers to the configuration information 45 before presenting the options of the GAD manual and the TI manual in the first inquiry return. The function usage status of the current set value 451 indicates that the GAD function is in use and the TI function is not in use. Therefore, the inquiry return program 231 according to the hierarchical structure automatically selects the GAD manual instead of the inquiry to request selection of the manual of these functions, and generates an inquiry for selection in the next hierarchy. In FIG. 9, the first inquiry return presents options in the chapter of CLI or API of the GAD manual.

The inquiry return program 231 according to the hierarchical structure may present a recommended option instead of the automatic selection of the option. For example, words indicating that GAD is recommended are displayed while presenting the GAD manual and the TI manual as options. In addition, a reason for recommendation may be displayed, for example, that the GAD is in use and the TI is not in use.

As described above, the inquiry return program 231 according to the hierarchical structure refers to the configuration information 45 before each inquiry return for narrowing down the items by the interaction described in the first embodiment, and determines whether or not automatic selection of the option or presentation of a recommended option is performed. A rule for determining a combination of a term to be referred to for determination and a portion of the configuration information and a recommended option may be set in the inquiry return program 231 according to the hierarchical structure in advance.

For example, in a case where the function of the apparatus is included in information to be presented for selection, the presence or absence of use of the function in the current set value 451 is referred to, and the function being used is prioritized over the function not being used. In the operation history 452 or the event log 453, in a case where an entry within a predetermined period includes a term (function, component, or the like) of an option or an item associated with the term in advance, the term may be prioritized. In a case where a plurality of terms are included in an entry within a predetermined period of time, a term of a latest entry may be prioritized. For example, a function or a component for which the most recent malfunction is reported may be recommended.

Different priorities may be given to different types of information in the configuration information 45. In a case where a highest priority is given to different terms for different types of information, a recommended term may be selected according to the priority of the information type. Alternatively, in a case where different terms are prioritized for different types of information, all options may be presented to the user without automatic selection or recommendation.

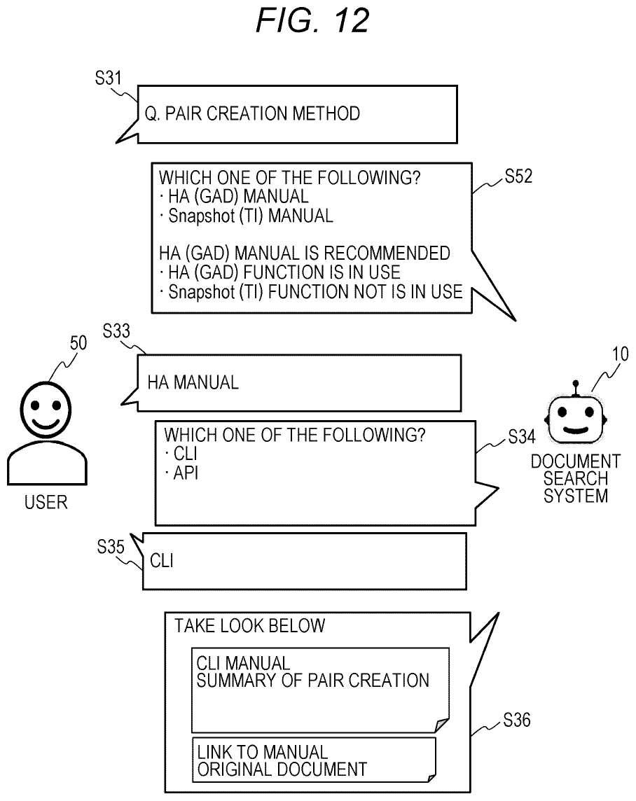

FIG. 12 illustrates an example of the interaction between the document search system 10 and the user 50 in the document search using the input keyword. As compared with the example illustrated in FIG. 8, a first inquiry return S52 by the document search system 10 is different from the first inquiry return S32 in FIG. 8. The inquiry return S52 recommends the selection of the GAD manual and shows the reason. As described above, the GAD manual may be automatically selected by the document search system 10 without performing the inquiry return S52.

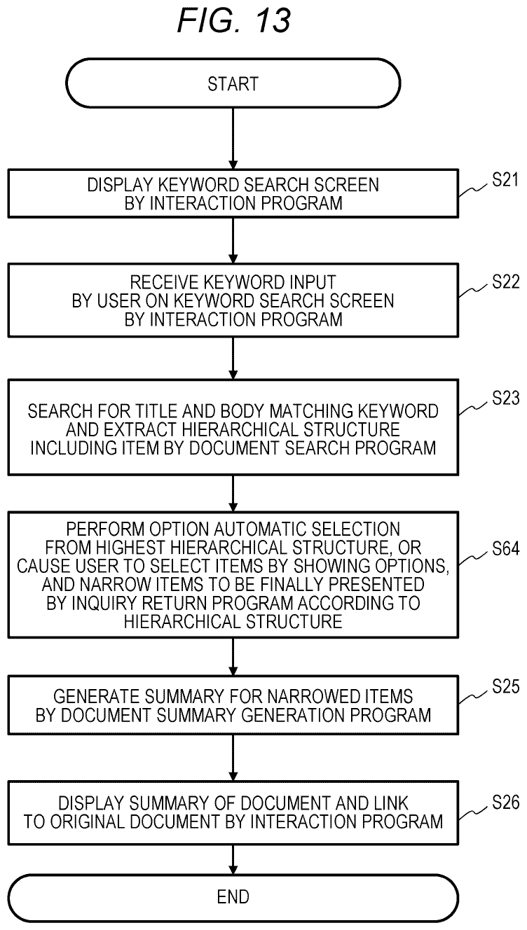

FIG. 13 is a flowchart illustrating an example of search processing in the present embodiment. As compared with the processing example illustrated in FIG. 7, step S34 is replaced with step S64. The other steps are identical. In step S64, the inquiry return program 231 according to the hierarchical structure causes the user to automatically select an item or causes the user to select an item by showing the options in order from the highest hierarchy of the hierarchical structure, and narrows down the items of which information is finally presented. The presentation of the options is to present the general term instead of or together with the technical term, similarly to the processing example illustrated in FIG. 7. As described above, the recommended option may be shown instead of the option automatic selection.

What is claimed is:

1. A document search system comprising:
a processor; and
a storage apparatus,
wherein
the storage apparatus stores a document search database indicating a content hierarchical structure of one or more documents, and
the processor is configured to:
receive a search keyword input from a user;
search the document search database for items matching the search keyword; and
determine a result item to be presented to the user from a plurality of items matching the search keyword by sequentially selecting items from a higher hierarchy to a lower hierarchy according to a content hierarchical structure including the plurality of items, and
the selection in at least one hierarchy follows selection by the user from a plurality of option items presented to the user.

2. The document search system according to claim 1, wherein the processor is configured to: present the plurality of option items to the user in each hierarchy until the number of item options becomes one; and select one from the plurality of option items according to the selection by the user.

3. The document search system according to claim 1, wherein the processor is configured to include, in the presenting of the plurality of option items to the user, general terms converted from technical terms in the plurality of option items by using a synonym dictionary.

4. The document search system according to claim 3, wherein the processor is configured to include both the technical terms and the general terms in the presenting of the plurality of option items to the user.

5. The document search system according to claim 1, wherein the processor is configured to absorb a notation deviation between a technical term and a general term by using a synonym dictionary in the searching for the items matching the search keyword.

6. The document search system according to claim 1, wherein the processor is configured to present, to the user, a summary based on the result item and a body of an item in a lower hierarchy of the result item.

7. The document search system according to claim 1, wherein
the storage apparatus stores configuration information of an apparatus used by the user, and
the processor is configured to:
search for information related to each of the plurality of option items with the configuration information in the selecting from the plurality of option items in the hierarchy; and
cause the user to select one option item based on the information related to each of the plurality of option items in the configuration information or present an option item recommended to the user.

8. A document search method, comprising storing, by a system, a document search database indicating a content hierarchical structure of one or more documents,
the document search method further comprising: by the system,
receiving a search keyword input by a user,
searching the document search database for items matching the search keyword, and
determining a result item to be presented to the user from a plurality of items matching the search keyword by sequentially selecting items from a higher hierarchy to a lower hierarchy according to a content hierarchical structure including the plurality of items, and
wherein the selection in at least one hierarchy follows selection by the user for an option of a candidate item presented to the user.
